(19) United States
(12) Patent Application Publication
(10) Pub. No.: US 2006/0170667 A1
(43) Pub. Date: Aug. 3, 2006

(54) Electrophoretic display with reduced power consumption

(76) Inventors: Guofu Zhou, Eindhoven (NL); Mark Thomas Johnson, Eindhoven (NL); Johannes Petrus Van De Kamer, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/564,538

(22) PCT Filed: Jul. 12, 2004
(86) PCT No.: PCT/IB04/51193

§ 371 Date: Jan. 12, 2006

(30) Foreign Application Priority Data
Jul. 17, 2003 (EP) 03102209.8

(51) Int. Cl. G09G 5/00

(52) U.S. Cl. 345/208

(57) ABSTRACT

This invention relates to an electrophoretic display panel, comprising:—a plurality of pixels, each containing an amount of an electrophoretic material comprising charged particles,—a first and a second electrode associated with each pixel for receiving a potential difference as defined by an update drive waveform; and—drive means, for controlling said update drive waveform of each pixel; wherein the charged particles, depending on the applied update drive waveform, are able to occupy a position being one of extreme positions near the electrodes and intermediate positions in between the electrodes for displaying the picture, and wherein said update drive waveform essentially comprises a first shaking portion, a reset portion, a second shaking portion and subsequently a driving portion, wherein the polarity of said first shaking portion is opposite the polarity of the second shaking portion.

This invention relates to an electrophoretic display panel, for displaying a picture corresponding to image information, comprising: a plurality of pixels, each containing an amount of an electrophoretic material comprising charged particles, being dispersed in a fluid; a first and a second electrode associated with each pixel for receiving a potential difference as defined by an update drive waveform; and drive means, for controlling said update drive waveform of each pixel; wherein the charged particles, depending on the applied update drive waveform, are able to occupy a position being one of extreme positions near the electrodes and intermediate positions in between the electrodes for displaying the picture, and wherein said update drive waveform essentially comprises: a first shaking portion, being data-independent, a reset portion, during which a reset signal is applied over the pixel, a second data-independent shaking portion being data-independent and subsequently a driving portion, during which a picture potential difference is applied over the pixel for enabling the particles to occupy the position corresponding to the image data information.

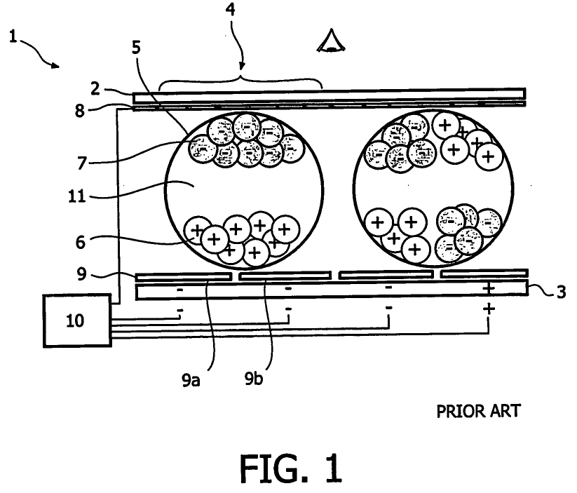

Electrophoretic display devices are based on motion of charged, usually coloured particles under the influence of an electric field. Such displays are suitable in paper-like display functions, such as electronic newspapers and electronic diaries. One type of electrophoretic display device comprises a plurality of microcapsules which are filled with a fluid. Each microcapsule also comprises a plurality of charged particles, the positions of which are controlled by the application of an electric field over the microcapsule. This is usually made by sandwiching a layer of microcapsules between a first and a second electrode. In a basic embodiment, coloured particles, such as black particles are dispersed in a white fluid (hereinafter referred to as one-particle type). Alternatively, at least two different types of coloured particles, having different charges, for example black negatively charged particles and white positively charged particles, are dispersed in a clear fluid (hereinafter referred to as two-particle type). This latter alternative is advantageous in that it increases the contrast of the pixel and allows sub-pixel addressing, which improves the resolution of the display. A detail from a display of the latter type is shown schematically in FIG. 1.

An example of an electrophoretic display device as mentioned above is described in the Patent application WO 02/07330 (one-particle type).

In the described electrophoretic display panel, each picture element has, during the display of the picture, an appearance determined by the position of the particles in each microcapsule. Hence, greyscales in such a display are generally created by applying a sequence of voltage pulses, referred to as an update drive waveform over each picture element for a specific time period. A large number of greyscales are desired for displaying a picture which looks natural. For this purpose, a variety of different update drive waveforms has been developed in order to generate different greyscales. A problem with this kind of display is however that the position of the particles do not only depend on the applied potential difference or waveform, but also on the history of the previously applied potential difference of each picture element. Moreover, the accuracy of the greyscales in electrophoretic displays is strongly influenced by other factors, such as the dwell time, temperature, humidity, and lateral imhomogeneity of the electrophoretic material. Most of the developed update drive waveforms require that the greyscale level of each picture element in an image to be displayed is compared to its state in the present image, and based upon this comparison, one of a series of waveforms is selected. Hence, in an example with four grey levels, it is necessary to store sixteen different wave forms, i.e. one wave form from each transition from any one to any one of the four grey levels. Grey levels in two-particle type displays are generated in a similar manner.

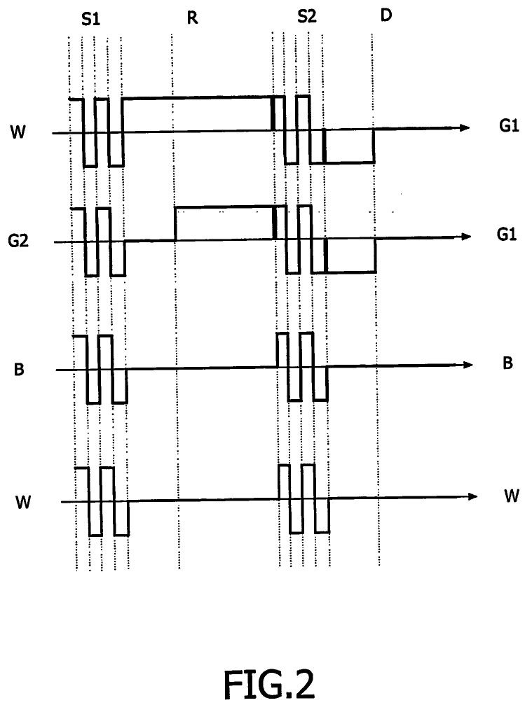

Accurate grey levels in the above types of electrophoretic displays may be achieved using a so-called rail-stabilized approach, which means that the grey levels are achieved either from a reference black state or from a reference white state (i.e. the two rails). An example of representative prior art driving waveforms is schematically disclosed in FIG. 2, for image transitions from the state white (W) to dark grey (G1), from light grey (G2) to dark grey (G1), from black (B) to black (B), and from white (W) to white (W), respectively. Each update drive waveform essentially comprises a first shake period (S1) (i.e. a first period of shaking pulses), a reset period (R), a second shake period (S2) (i.e. a second period of shaking pulses) and a greyscale drive period (D). In order to reduce the dependency of the optical response of the electrophoretic display unit on the history of the pixels, shaking pulses, comprising preset data signals, are supplied. These preset data signals comprise data pulses representing energies which are sufficient to release the electrophoretic particles from static state at one of the two electrodes, but which are too low to allow the electrophoretic particles to reach the other one of the electrodes. Both the first and second shake periods (S1, S2) are applied at the same time for all pixels of a display, independent of the data information that is to be displayed by each pixel, in order to enhance the efficiency and to reduce the power consumption of the display. This is also referred to as hardware shaking. Hence, pixels subjected to same level transitions, such as white to white (W-W) or black to black (B-B) also receive both a first shaking pulse and a second shaking pulse during the first and second shake periods, respectively.

An issue with this approach is however that an additional single polarity driving pulse is required after the above driving pulses in order to correct brightness drift induced by the above shaking pulses. This results in an increased power consumption and a remnant DC voltage on the pixel, which leads to a larger image retention in the next image update.

Hence, it is, inter alia, an object of this invention is to achieve an electrophoretic display having a reduced greyscale drift compared with that of the prior art electrophoretic displays.

This object is at least in part achieved by an electrophoretic display panel by way of introduction, characterized in the polarity of said first shaking portion is opposite the polarity of the second shaking portion. By arranging so that the polarity of said first shaking portion is exactly opposite the polarity of the second shaking portion, the total greyscale drift induced by hardware shaking (shaking occurs on the whole display, regardless of the pixel data) may be significantly reduced. A further advantage is that, due to this, it is not always necessary to update pixels with greyscale transitions to the same level, which significantly reduces the power consumption of the display panel and also reduces the remnant DC voltage.

Preferably, each of the shaking portions comprises an even number of shaking pulses. This further reduces the greyscale drift.

According to an embodiment of this invention, the update drive waveform further comprises an additional drive pulse after said second shaking portion. Said update waveform is arranged to be used for transitions from one greyscale to the same greyscale at or close to the extreme optical states. This improves the greylevel drift during repeated updating with transitions to the same level. Preferably, the additional drive pulse has a polarity such as to move the particles towards the extreme optical state which is closest to their present optical state. This further limits the greyscale drift with a very limited amount of remnant DC voltage.

According to an embodiment of this invention, the update drive waveform further comprises an additional reset pulse before said second shaking portion and an additional drive pulse after said second shaking portion. Said update drive waveform is arranged to be used for transitions from one grayscale to the same greyscale. This improves the greylevel drift during repeated updating with transitions to the same level. Said additional reset pulse and said additional drive pulse may be of equal length. Preferably, the additional drive pulse has a polarity such as to move the particles towards the extreme optical state which is closest to their present optical state. This further limits the greyscale drift without introducing additional DC voltages. Alternatively, said additional drive pulse is longer than said additional reset pulse, which further improves the greyscale drift, and enables a constant greyscale with a very limited amount of remnant DC voltage.

The above and other objects of this invention are also achieved by a drive means for driving an electrophoretic display device, the device comprising a plurality of pixels, each containing an amount of an electrophoretic material comprising charged particles being dispersed in a fluid, and a first and a second electrode associated with each pixel for receiving a potential difference as defined by an update drive waveform, the drive means being arranged to control the update drive waveform, wherein the update drive waveform comprises: a first shaking portion, being data independent, a reset portion, during which a reset signal is applied over the pixel, a second data-independent shaking portion being data-independent and subsequently enabling the particles to occupy the position corresponding to image date information characterized in that the polarity of said first shaking portion is opposite the polarity of the second shaking portion. In the same way as described above, the inventive drive means assured that the total grey scale drift induced by hardware shaking may be significantly reduced.

This invention will hereinafter be described in closer detail by means of preferred embodiments thereof, with reference to the accompanying drawings.

FIG. 1 is a schematic cross-section view of two adjacent microcapsules in a display device according to the prior art, and to which the present invention may be applied.

FIG. 2 is a diagram over examples of prior art waveforms used to drive a microcapsule as disclosed in FIG. 1.

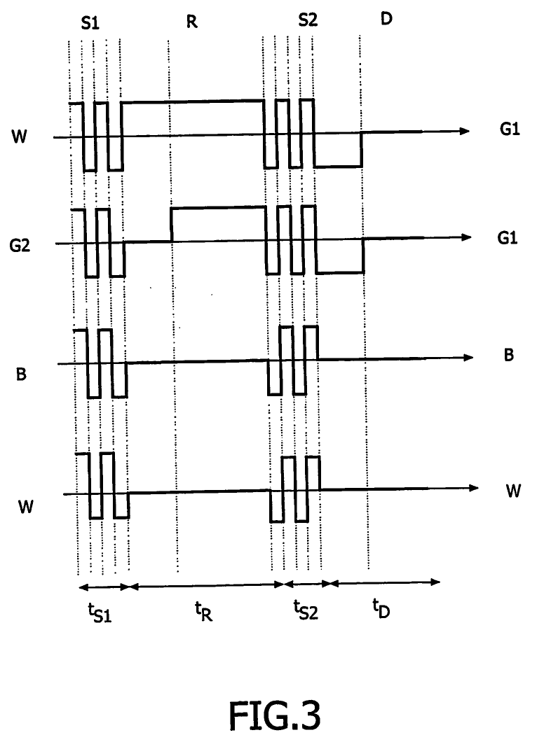

FIG. 3 is a diagram disclosing a set of drive waveform examples according to a first embodiment of this invention.

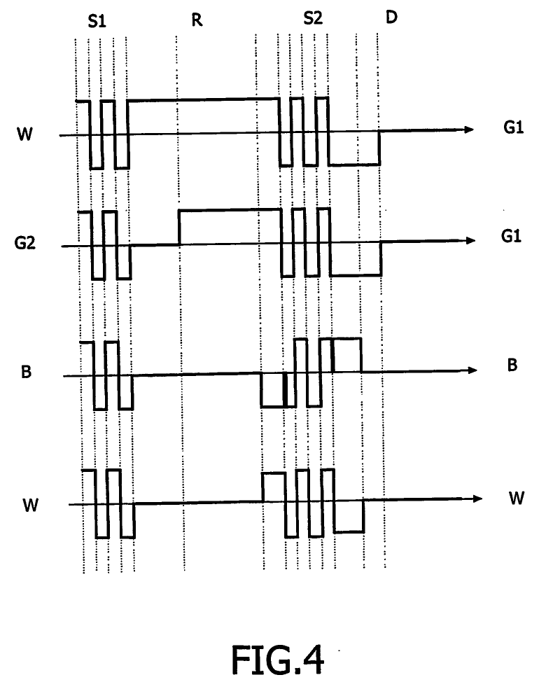

FIG. 4 is a diagram disclosing a set of drive waveform examples according to an alternative embodiment of this invention.

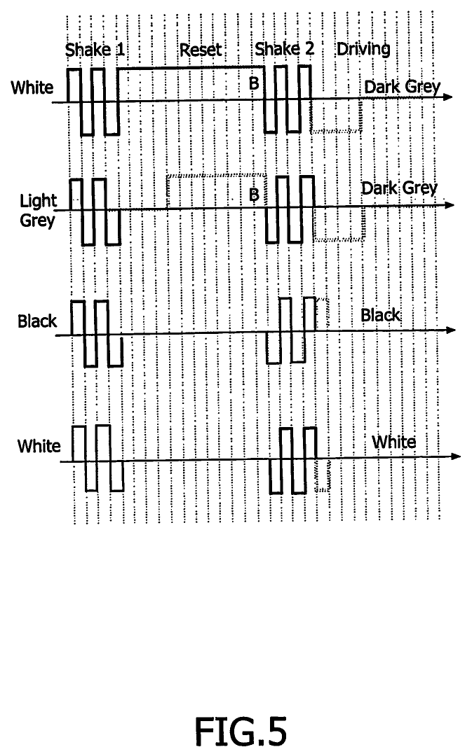

FIG. 5 is a diagram disclosing a set of drive waveform examples according to yet an alternative embodiment of this invention.

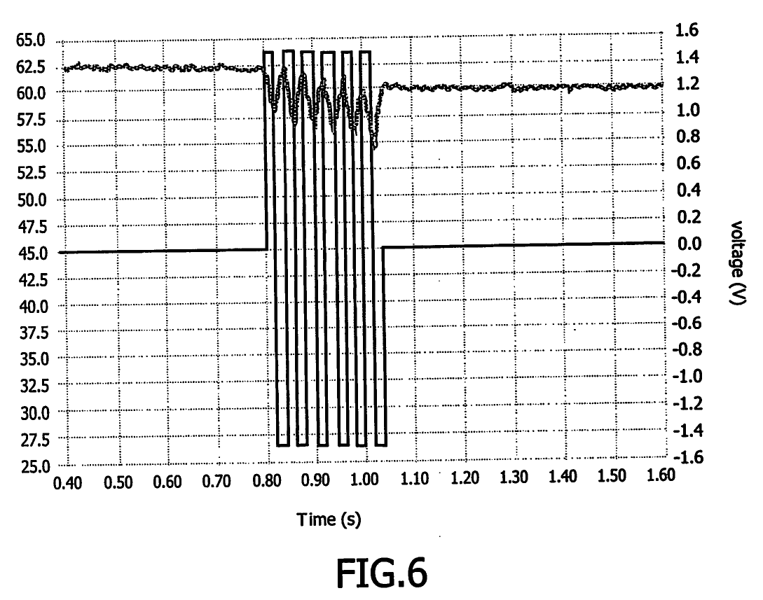

FIG. 6 is a schematic diagram illustrating the greyscale drift during a set of shaking pulses.

FIG. 1 shows an embodiment of an electrophoretic display panel 1, to which the present invention may be applied. The display panel 1 comprises a first transparent substrate 2, a second opposite substrate 3 and a plurality of pixels 4, each in this case being constituted by a microcapsule 5. Each microcapsule contains an electrophoretic material, such as an amount of light particles 6 and dark particles 7, suspended in a clear fluid. Electrophoretic materials for use in the microcapsules are known in the prior art and will therefore not be closer described herein. The light particles 6 and the dark particles 7 are mutually different charged. In this example the light particles are essentially white, positively charged particles, while the dark particles are essentially black, negatively charged particles. The electrophoretic display panel 1 further comprises a first electrode means 8 and a second electrode means 9, associated with each pixel 4. The electrodes 8, 9 are connected to a driver 10 in order to receive a potential difference. The driver 10 is arranged to provide the electrodes 8,9 with a suitable update drive waveform in order to control the applied potential difference. Further, the second electrode means 9 for each pixel 4 may or may not comprise two individually controllable electrodes 9a, 9b (see FIG. 1), in order to provide sub-pixel resolution. These electrodes may in certain circumstances further be used to move the particles in a direction in the plane of the substrates. In an active matrix embodiment, each pixel 4 further comprises switching electronics (not shown) on per se known manner, comprising for example thin film transistors (TFTs), diodes or MIM devices.

By applying an update drive waveform, and hence a varying potential difference, over the electrodes 8,9, the charged particles 6, 7 within the microcapsule 5 may be moved within the microcapsule in order to occupy different parts thereof, hence changing the visual appearance of the microcapsule. Depending on the size of the applied potential difference, the charged particles 6, 7 may be moved between a first and a second extreme position, giving rise to for example the visual appearances black (B) and white (W), and may also be moved to intermediate positions, giving rise to for example the visual appearances light grey (G2) and dark grey (G1). Of course, a larger amount of grey scales may be achieved, but for clarity, this description is focused on a device which has for states, i.e. B, W, G1 and G2. In order to transfer each of said states to every other state, 16 specific transition drive waveforms are used, one for each transition. Hence, the driver 10 is arranged to control the potential difference applied over each pixel by applying a suitable one of said drive waveforms over the pixel in order to transition the pixel from a first to a second state. Each drive waveform or pulse sequence essentially consists of four waveform portions, a first shaking pulse portion S1, having a duration t_{S1}, a reset portion R, having a duration t_{R}, a second shaking portion S2, having a duration t_{S2} and a greyscale driving portion D, having a duration t_{D}. As indicated above, an example of four such drive waveforms according to the prior art are shown in FIG. 2.

This invention is based on the realisation that if the polarity of the first and second data-independent shaking portions S1 and S2 is exactly opposite to each other in all types of update drive waveforms, an active matrix electrophoretic display device with at least two bits greyscale, having a reduced power consumption and exhibiting stable grey scales, may be achieved. As seen in for example FIG. 3, each shaking pulse is of equal length (i.e. t_{S1}=t_{S2}), have the same number of pulses, although their polarity is exactly opposite. In this way, the total greyscale drift, induced by hardware shaking is significantly reduced (shaking occurs on the whole display, regardless of the pixel data). Hence, it is not always necessary to update the pixels with greyscale transitions to the same grey level (for example, white to white), which further may reduce the power consumption and the remnant DC-voltage, and thus the image retention.

Usually, an even number of shaking pulses is used within each shaking pulse period S1, S2. Nevertheless, the brightness of the display tends to drift toward a different grey level. For pixels at, or close to, the extreme optical states, the grey scale drift tends to be towards the middle grey levels—i.e. away from the extreme optical state—since it is difficult to move the particles further towards the extreme state than they are initially and any net motion can only be away from the extreme optical state. For pixels at intermediate optical states, the optical drift depends upon the polarity of the shaking pulses, since the mobility of the particles increases during the series of preset pulses and therefore the particle motion is greater for the second pulse (and all subsequent even numbered pulses) than for the first pulse (and all the subsequent previous odd numbered pulses). The degree of this drift therefore depends strongly on shaking pulse time period, the number of shaking pulses and the sign of the last shaking pulse. Hence, even when an even number of shaking pulses is used within each shaking pulse period S1, S2 a small brightness drift is observed. However, this drift could be much larger if an odd number of pulses were to be applied. In addition the total greyscale drift will be doubled when shake 1 and shake 2 with same polarity are used. An example of this is disclosed in FIG. 6. This schematic drawing shows an example of the brightness drift induced by a series of 12 shaking pulses at white state. The shaking pulse time period is 20 ms starting with positive pulse and ending with negative pulse, which gives the minimum brightness drift after shaking. A brightness drift of about 2.5 L* is observed. However, this drift would be much larger (e.g. 7.5 L*) if the last pulse ends with positive sign. The total greyscale drift will be doubled when shake 1 and shake 2 with same polarity are used as in the prior art (see FIG. 2).

A first embodiment of this invention will hereinafter be described in closer detail with reference to FIG. 3. The representative drive waveforms corresponds to the ones according to the prior art of FIG. 2. A may be seen in FIG. 3, the polarity of the second shake portion S2 is exactly opposite the polarity of the first shake portion S1. The first shaking portion S1 starts with a positive pulse (a positive voltage) and ends up with a negative pulse (a negative voltage). After the first shaking portion S1, a white state will experience a slight drift, while a black state will experience a somewhat larger drift. However, the subsequent second shaking portion S2 has opposite polarity, and starts with a negative pulse (a negative voltage) and ends up with a positive pulse (a positive voltage). In this way, the drifted black state is somewhat corrected to the desired darker state, due to the last positive pulse, while the white state remains essentially constant. In this way, with the drive waveform according to the invention, the brightness of both black and white states is virtually unchanged, and not visible for a human eye. Hence, it is not necessary to update a pixel with a waveform for transition to the same grey level, which significantly reduces the power consumption and the remnant DC voltage, and thus the image retention.

A second embodiment of this invention will hereinafter be described in closer detail with reference to FIG. 5. The representative drive waveforms corresponds to the ones according to the prior art of FIG. 2. This embodiment differs from the first embodiment described above in that the waveforms that are to control transitions to the same grey level at or close to the extreme optical states i.e. white-to-white (W-W) or black-to-black (B-B), further comprise an additional drive pulse DP, being positioned after the second shaking portion S2. In a preferred embodiment, the additional drive pulse has a polarity such as to move the particles towards the extreme optical states closest to their present optical state. This embodiment is especially advantageous when a pixel is to be repeatedly updated with transitions to the same grey level at or close to the extreme optical states. In this case, with the prior art drive waveforms, the total greyscale drift will be integrated and finally become unacceptable. The inventors behind this application have experimentally observed that the optical response at, or close to, the extreme optical states, tends to be towards the middle grey levels—i.e. away from the extreme optical state. Hence, in accordance with this embodiment of the invention, the greyscale may be kept at a constant level if an additional drive pulse is applied after the second shaking portion as indicated above, a very limited amount of remnant DC voltage being introduced.

A third embodiment of this invention will hereinafter be described in closer detail with reference to FIG. 4. The representative drive waveforms corresponds to the ones according to the prior art of FIG. 2. This embodiment differs from the first embodiment described above in that the waveforms that are to control transitions to the same grey level, such as white-to-white (W-W) or dark grey-to-dark grey (DG-DG), further comprises an reset pulse RP and an additional drive pulse DP, being symmetrically arranged on opposite sides of the second shaking portion S2. This embodiment is especially advantageous when a pixel is to be repeatedly updated with transitions o the same grey level. In this case, with the prior art drive waveforms, the total greyscale drift will be integrated and finally become unacceptable. The inventors behind this application have experimentally observed that the optical response before the shaking pulses is much less than after the shaking pulses. Hence, in accordance with this embodiment of the invention, the greyscale may be kept at a constant level if even, symmetric pulses (i.e. the reset and drive pulses RP and DP) are applied before and after the shaking pulse as indicated above, while the DC is balanced. According to one variant, the reset and drive pulses are of the same length. In a preferred embodiment, the additional drive pulse has a polarity such as to move particles towards the extreme optical states closest to their present optical state. This further limits the greyscale drift without introducing additional DC voltages. According to a second variant, the driving pulse, i.e. the pulse that is applied after the second shaking portion S2 may be longer than the reset pulse, applied before the second shaking portion S2. This latter variant is advantageous when the pixel is to be frequently and repeatedly updated with transitions to the same grey level. In this way, the greyscale may be kept constant with a very limited amount of remnant DC voltage. According to a further variant, the driving pulse, i.e. the pulse that is applied after the second shaking portion S2 may be longer than the reset pulse, applied before the second shaking portion S2. This latter variant is advantageous when the pixel is to be frequently and repeatedly updated with transitions to the same grey level. In this way, the greyscale may be kept constant with a very limited amount of remnant DC voltage.

1. An electrophoretic display panel (1), for displaying a picture corresponding to image information, comprising:
a plurality of pixels (2), each containing an amount of an electrophoretic material comprising charged particles (6, 7), being dispersed in a fluid (11);
a first and a second electrode (8, 9) associated with each pixel (4) for receiving a potential difference as defined by an update drive waveform; and
drive means (10), for controlling said update drive waveform of each pixel (4);
wherein the charged particles (6,7), depending on the applied update drive waveform, are able to occupy a position being one of extreme positions near the electrodes (8,9) and intermediate positions in between the electrodes (8,9) for displaying the picture, and wherein said update drive waveform essentially comprises:
a first shaking portion (S1), being data-independent,
a reset portion (R), during which a reset signal is applied over the pixel,
a second data-independent shaking portion (S2) being data-independent and subsequently
a driving portion (D), during which a picture potential difference is applied over the pixel for enabling the particles (6, 7) to occupy the position corresponding to the image data information, characterized in that the polarity of said first shaking portion (S1) is opposite the polarity of the second shaking portion (S2).

2. An electrophoretic display panel as in claim 1, wherein each of the shaking portions (S1, S2) comprises an even number of shaking pulses.

3. An electrophoretic display panel as in claim 1, wherein the update drive waveform further comprises an additional drive pulse (DP) after the second shaking portion (S2).

4. An electrophoretic display panel as in claim 3, wherein said update drive waveform is arranged to be used for transitions from one greyscale to the same greyscale.

5. An electrophoretic display panel as in claim 3, where the additional drive pulse (DP) has a polarity such as to move the particles (6,7) towards an extreme optical state being closest to their present optical state.

6. An electrophoretic display panel as in claim 1, wherein the update drive waveform further comprises an additional reset pulse (RP) before said second shaking portion (S2) and an additional drive pulse (DP) after second shaking portion (S2).

7. An electrophoretic display panel as in claim 6, wherein said additional reset pulse (RP) and said additional drive pulse (DP) have opposite polarity.

8. An electrophoretic display panel as in claim 6, where the additional drive pulse (DP) has a polarity such as to move the particles (6,7) towards an extreme optical state being closest to their present optical state.

9. An electrophoretic display panel as in claim 6, wherein said additional reset pulse (RP) and said additional drive pulse (DP) are of equal length.

10. An electrophoretic display panel as in claim 6, wherein said additional drive pulse (DP) is longer than said additional reset pulse (RP).

11. Drive means for driving an electrophoretic display device, the device comprising a plurality of pixels (2), each containing an amount of an electrophoretic material comprising charged particles (6, 7) being dispersed in a fluid (11), and a first and a second electrode (8, 9) associated with each pixel (4) for receiving a potential difference as defined by an update drive waveform,
the drive means being arranged to control the update drive waveform, wherein the update drive waveform comprises:
a first shaking portion, being data independent,
a reset portion (R), during which a reset signal is applied over the pixel,
a second data-independent shaking portion (S2) being data-independent and subsequently enabling the particles (6, 7) to occupy the position corresponding to image date information
characterized in that the polarity of said first shaking portion (S1) is opposite the polarity of the second shaking portion (S2).
